(19) United States
(12) Patent Application Publication
(10) Pub. No.: US 2003/0107563 A1
(43) Pub. Date: Jun. 12, 2003

(54) Driving system and driving program for flat display apparatus

(75) Inventor: Naruhiro Sato, Fukuroi-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/288,568

(22) Filed: Nov. 6, 2002

(30) Foreign Application Priority Data
Nov. 7, 2001 (JP) P2001-341780

(51) Int. Cl. G09G 5/00

(52) U.S. Cl. 345/204

(57) ABSTRACT

A driving system comprises a driver circuit subsystem that drives cells of a plasma display panel (PDP), a detector subsystem that detects vertical sync signals in an input video signal at preset time intervals, a self-running sync signal generator subsystem that generates sync signals of a self-running type based on a clock thereof, and a sync signal switching subsystem that outputs the self-running sync signals in place of the vertical sync signals when the vertical sync signals are not detected. When input video signals are absent, the driving system uses the self-running sync signals to perform display control over the PDP.

### BACKGROUND OF THE INVENTION

1. Field of the Invention

The present invention relates generally to driver circuitry for displaying images on plasma display panels, and particularly to driver circuitry for illuminating a plasma display panel during the absence of input video signals.

2. Description of Related Art

Plasma display panels (PDPs) are attracting attention as promising technology for flat, lightweight display devices in recent years. The PDPs, which are driven completely differently from conventional CRTs, employ a direct driving method using digitized input video signals.

The direct driving method comes in two types: an alternating current (AC) type and a direct current (DC) type, which are basically different from each other in their characteristics. The AC type is the current mainstream.

An AC plasma display panel (AC PDP) displays images utilizing emission at crossings of row and column electrodes in cells which are arranged in a matrix form across the PDP. The emission is caused to occur through ionization of a low-pressure gas to initiate a plasma discharge. It is of note that the AC PDP maintains its display by the emission by sustaining the discharge at each cell through alternate application of sustain voltage waveforms to a pair of sustain (i.e., column) electrodes.

Specifically, a discharge takes place at each cell (discharge space) for a duration of from one to several microseconds immediately after application of a pulse. Ions, which are positive charges produced by the discharge, are stored on a surface of an insulating layer on an electrode to which a negative voltage is applied, and electrons, which are negative charges, are similarly stored on a surface of an insulating layer on an electrode to which a positive voltage is applied.

When a relatively high voltage (write voltage) pulse (write pulse) of a first polarity is applied to a cell to start a discharge (writing discharge) to generate wall charges and then a voltage (sustain voltage) pulse (sustain pulse) of a second polarity, which is lower than the write voltage, is thereafter applied, this sustain pulse is superimposed on the stored wall charges, increasing a potential across the discharge space in excess of its discharge threshold to start a sustaining discharge.

That is, when the sustain pulse is applied after generation of the wall charges, the electrons and the positive ions move in opposite directions, respectively, to cause, electrons to initiate bombardment with molecules or atoms within the discharge space to produce more ions as well as excited molecules or atoms, etc. These excited molecules or atoms emit light to illuminate each of the cells extended across the PDP.

Therefore, when each cell, which has built up the wall charges via the write pulse, is supplied with sustain pulses that alternate between the first and second polarities, the discharge can be sustained at the cell. When the number of such sustain pulses, i.e., the frequency of such sustain pulses increases, so does the number of emissions per unit time, providing an advantage of brighter display.

AC PDPs utilize this advantage termed as “memory effect” or “memory function” for their display. In the AC PDPs, the larger the number of wall charges, the more stable their discharge.

However, the AC plasma display panels having the memory effect addresses the problem of overload when input of video signals is temporarily interrupted. During a temporary absence of input video signals, the relatively high write voltage needs to be established from zero, overloading their driver electronics, unlike during a continuous input of video signals in which the same electronics merely need to add to the write voltage established for previous video information only a difference therefrom upon change to newly input video information.

The same problem is encountered when the sustain voltages are applied. When input video signals are temporarily absent, the sustain voltages need to be established from zero, thereby overloading their driver electronics unlike during a continuous input of video signals in which the same electronics merely need to add to the sustain voltages established for the previous video information only a difference therefrom upon change to the newly input video information.

### SUMMARY OF THE INVENTION

To solve the above problems, the present invention provides a driving system for a plasma display panel which can control display based on self-running sync signals when video signals are not supplied.

The above object of the present invention can be achieved by a system of the present invention for driving a flat display apparatus, which receives an input video signal from an external source to drive the flat display apparatus. The system is provided with; a detecting device which detects vertical sync signals in the input video signal; a sync signal generating device which generates self-running sync signals, which are sync signals of a self-running type; and an outputting device which outputs the self-running sync signals in place of the vertical sync signals when the vertical sync signals are not detected by the detecting device.

According to this invention, when the vertical sync signals in the input video signal to be received from the external source are not detected, the self-running sync signals are output to the flat display apparatus in place of the vertical sync signals.

Therefore, when the video signal is not supplied from the external source, if display control is effected by outputting the self-running sync signals to the flat display apparatus in place of the vertical sync signals and also by generating video information such as so-called blue background data for providing a blue background over the entire display screen surface and/or character data together with the self-running sync signals, then the flat display apparatus can display some video information even during absence of the video signal. As a result, the flat display apparatus allows the driver circuit to reduce overloads associated with the driver circuit having to establish write and sustain pulse voltages from zero at and after an interruption of video display.

In one aspect of the present invention, when the vertical sync signals are not detected by the detecting device at preset time intervals, the outputting device outputs the self-running sync signals generated by the sync signal generating device, in place of the vertical sync signals.

According to this aspect, when the vertical sync signals in the input video signal to be received from the external source are not detected at the preset time intervals, the self-running sync signals are output to the flat display apparatus in place of the vertical sync signals.

Therefore, when the video signal is not supplied from the external source, if display control is effected by outputting the self-running sync signals to the flat display apparatus in place of the vertical sync signals and also by generating video information such as so-called blue background data for providing a blue background over the entire display screen surface and/or character data together with the self-running sync signals, then the flat display apparatus can display some video information even during absence of the video signal. As a result, the flat display apparatus allows the driver circuit to reduce overloads associated with the driver circuit having to establish write and sustain pulse voltages from zero at and after an interruption of video display.

In another aspect of the present invention, the flat display apparatus driven by the system is a plasma display panel.

According to this aspect, when the plasma display panel does not receive the input video signal from the external source, the plasma display panel allows the driver circuit to alleviate overloads associated with the driver circuit having to establish write and sustain pulse voltages from zero at and after any interruption of video display.

The above object of the present invention can be achieved by a program embodied in a recording medium of the present invention for driving a flat display apparatus, which is processed by a computer based on an input video signal received from an external source. The program causes the computer to function as: a detecting device which detects vertical sync signals in the input video signal; a sync signal generating device which generates self-running sync signals, which are sync signals of a self-running type; and an outputting device which outputs the self-running sync signals in place of the vertical sync signals when the vertical sync signals are not detected by the detecting device.

According to this invention, when the vertical sync signals in the input video signal to be received from the external source are not detected, the self-running sync signals are output to the flat display apparatus in place of the vertical sync signals.

Therefore, when the video signal is not supplied from the external source, if display control is effected by outputting the self-running sync signals to the flat display apparatus in place of the vertical sync signals and also by generating video information such as so-called blue background data for providing a blue background over the entire display screen surface and/or character data together with the self-running sync signals, then the flat display apparatus can display some video information even during absence of the video signal. As a result, the flat display apparatus allows the driver circuit to reduce overloads associated with the driver circuit having to establish write and sustain pulse voltages from zero at and after an interruption of video display.

In one aspect of the present invention, when the vertical sync signals are not detected by the detecting device at preset time intervals, the outputting device outputs the self-running sync signals generated by the sync signal generating means, in place of the vertical sync signals.

According to this aspect, when the vertical sync signals in the input video signal to be received from the external source are not detected at the preset time intervals, the self-running sync signals are output to the flat display apparatus in place of the vertical sync signals.

Therefore, when the video signal is not supplied from the external source, if display control is effected by outputting the self-running sync signals to the flat display apparatus in place of the vertical sync signals and also by generating video information such as so-called blue background data for providing a blue background over the entire display screen surface and/or character data together with the self-running sync signals, then the flat display apparatus can display some video information even during absence of the video signal. As a result, the flat display apparatus allows the driver circuit to reduce overloads associated with the driver circuit having to establish write and sustain pulse voltages from zero at and after an interruption of video display.

In another aspect of the present invention, the flat display apparatus driven by the system is a plasma display panel.

According to this aspect, then the flat display apparatus can display some video information even during absence of the video signal. As a result, the flat display apparatus allows the driver circuit to reduce overloads associated with the driver circuit having to establish write and sustain pulse voltages from zero at and after an interruption of video display.

### BRIEF DESCRIPTION OF THE DRAWINGS

FIG. 1 is a block diagram showing a configuration of a driving system for a PDP according to a preferred embodiment of the present invention; and

FIG. 2 is a flowchart showing a switching process according to the preferred embodiment of the present invention.

### DETAILED DESCRIPTION OF THE PREFERRED EMBODIMENT

A preferred embodiment of the present invention will now be described with reference to the accompanying drawings.

The following description refers to a case where the present invention is applied to a driving system for a plasma display panel (PDP).

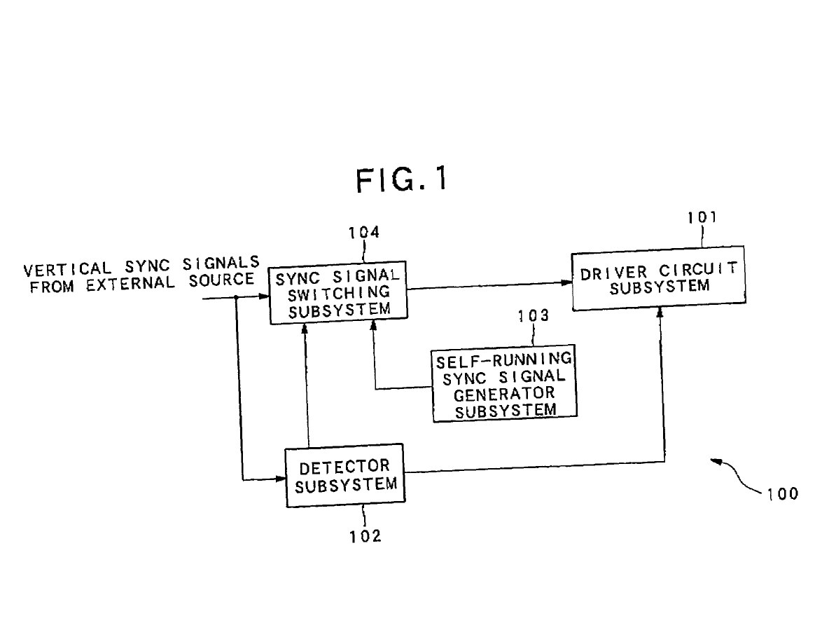

As shown in FIG. 1, the driving system 100 according to the preferred embodiment comprises a driver circuit subsystem 101 that drives cells of the PDP, a detector subsystem 102 that detects vertical sync signals included in video signals supplied from an external source, a self-running sync signal generator subsystem 103 that generates sync signals of a self-running type (self-running sync signals) based on a clock thereof, and a sync signal switching subsystem 104 that outputs the self-running sync signals in place of the vertical sync signals when vertical sync signals in an externally input video signal are not detected.

The detector subsystem 102 and the self-running sync signal generator subsystem 103 constitute a detecting device and a sync signal generating device of the present invention, respectively, while the driver circuit subsystem 101 and the sync signal switching subsystem 104 collectively constitute an outputting device of the present invention.

The driver circuit subsystem 101 includes a driver circuit for driving the cells. The driver circuit converts input video signals into video information for each cell, and controls, for example, application of write and sustain pulse voltages.

To generate, from vertical sync signals in video signals, the corresponding video information for each cell, the driver circuit subsystem 101 is arranged to receive both vertical sync signals and video signals (not shown). That is, after generating the video information, the driver circuit subsystem 101 performs drive and display control by, for example, controlling the driving of write and sustain pulse voltages for proper display of the generated video information.

The driver circuit subsystem 101 also includes a data generator to cope with a temporary absence of video signals. The data generator intervenes upon receipt of a control instruction signal from the detector subsystem 102, as will be described below, when there is an interruption of input video signals. That is, when the detector subsystem 102 does not detect a vertical sync signal and hence sends the control instruction signal to the driver circuit subsystem 101, the data generator generates data such as so-called blue background data and/or character data so that the driver circuit subsystem 101 can drive each cell based on the generated blue background data and/or character data together with the self-running sync signals. The blue background data herein means data for covering the entire display surface of the PDP in blue, while the character data means any data representing characters, symbols, etc.

In this embodiment, the blue background data or the character data is output to the PDP either automatically or via an operation using an operating subsystem (not shown), upon switching to a drive with self-running sync signals.

The detector subsystem 102 is arranged to receive vertical sync signals in an input video signal. The detector subsystem 102 also includes a counter that detects receipt of the vertical sync signals at predetermined time intervals.

This detector subsystem 102 also outputs control instruction signals. When detecting a vertical sync signal within a counter preset time interval, i.e., when detecting a first vertical sync signal, the detector subsystem 102 causes the counter to measure another preset time interval, and if not detecting a second vertical sync signal within that measured preset time interval, then the detector subsystem 102 determines that no vertical sync signal is input from the external source, and hence instructs the sync signal switching subsystem 104 to switch sync signals for output therefrom to self-running sync signals generated by the self-running sync signal generator subsystem 102, and gives the driver circuit subsystem 101 a control instruction signal for driving the PDP based on the self-running sync signals.

The self-running sync signal generator subsystem 103 generates sync signals based on its own clock, and supplies the generated sync signals, i.e., self-running sync signals, to the sync signal switching subsystem 104.

The sync signal switching subsystem 104 is arranged to receive the above-mentioned control instruction signal from the detector subsystem 102, as well as the vertical sync signals and self-running sync signals, so that the self-running sync signals can be output in place of the vertical sync signals based on the control instruction signal.

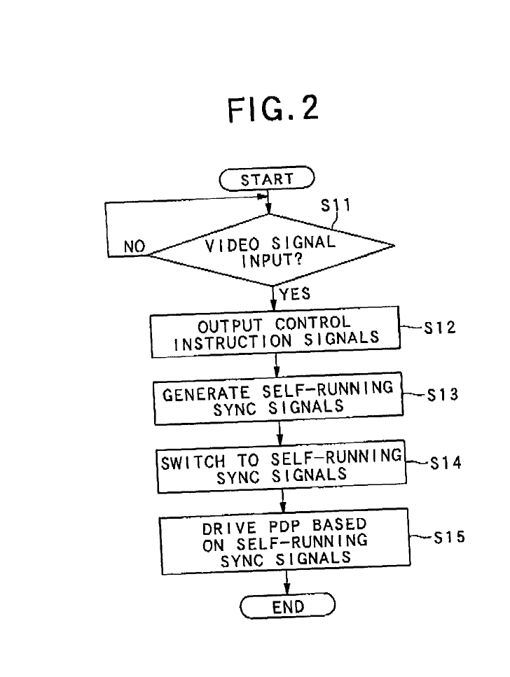

Referring next to FIG. 2, a switching process according to this embodiment will be described, by which switching is performed between vertical sync signals and self-running sync signals when there is a pause in receiving video signals.

In FIG. 2, which is a flowchart showing steps of the switching process, it is supposed that the driver circuit subsystem 101 has already received an input video signal and thus the corresponding vertical sync signals have already been input to its driver circuit.

First, the detector subsystem 102 determines whether or not the vertical sync signals in the video signal are detected at the preset time intervals (step S11). If no vertical sync signals are detected at the preset time intervals, then the detector subsystem 102 gives the sync signal switching subsystem 104 a control instruction signal to cause the switching subsystem 104 to switch to self-running sync signals, and also gives the driver circuit subsystem 101 a control instruction signal to inform the driver circuit subsystem 101 that switching will occur to self-running sync signals (step S12) Meantime, the self-running sync signal generator subsystem 103 generates self-running sync signals based on its own clock (step S13).

The self-running sync signals may be generated either constantly or based on a control instruction signal received from the detector subsystem 102.

Then, responsive to the control instruction signal from the detector subsystem 102, the sync signal switching subsystem 104 switches sync signals for output therefrom to the self-running sync signals received from the self-running sync signal generator subsystem 103 (step S14).

Finally, the driver circuit subsystem 101 generates video information corresponding to the self-running sync signals, and blue background data and/or character data for each cell of the PDP, and performs drive and display control for the generated video information accordingly (step S15).

As described above, according to this embodiment, when vertical sync signals of a video signal input from the external source are not detected, the PDP can be driven by self-running sync signals in place of the vertical sync signals. This permits the PDP to display some video information even in the absence of input video signals, through display control involving generation of video information from so-called blue background data for providing a blue background across the entire PDP surface and/or character data, together with the self-running sync signals.

Thus, the PDP allows its driver circuit to alleviate overloads associated with the driver circuit having to establish write and sustain pulse voltages from zero at and after any interruption of video display.

As described in the foregoing, according to the present invention, if display control is effected by outputting self-running sync signals to a flat display apparatus in place of vertical sync signals and also by generating video information corresponding to so-called blue background data and/or character data together with the self-running sync signals when video signals are not supplied from an external source, then the flat display apparatus can display some video information even during the absence of the video signals, whereby the flat display apparatus allows its driver circuit to reduce overloads associated with the driver circuit having to establish write and sustain pulse voltages from zero at and after any pause of video display.

The entire disclosure of Japanese Patent Application No. 2001-341780 filed on Nov. 7, 2001 including the specification, claims, drawings and summary is incorporated herein by reference in its entirety.

What is claimed is:

1. A system for driving a flat display apparatus, which receives an input video signal from an external source to drive the flat display apparatus, the system comprising:
a detecting device which detects vertical sync signals in the input video signal;
a sync signal generating device which generates self-running sync signals, which are sync signals of a self-running type; and
an outputting device which outputs the self-running sync signals in place of the vertical sync signals when the vertical sync signals are not detected by the detecting device.

2. The system according to claim 1, wherein when the vertical sync signals are not detected by the detecting device at preset time intervals, the outputting device outputs the self-running sync signals generated by the sync signal generating device, in place of the vertical sync signals.

3. The system according to claim 1, wherein the flat display apparatus driven by the system is a plasma display panel.

4. A program embodied in a recording medium for driving a flat display apparatus, which is processed by a computer based on an input video signal received from an external source, the program causing the computer to function as:
a detecting device which detects vertical sync signals in the input video signal;
a sync signal generating device which generates self-running sync signals, which are sync signals of a self-running type; and
an outputting device which outputs the self-running sync signals in place of the vertical sync signals when the vertical sync signals are not detected by the detecting device.

5. The program embodied in a recording medium according to claim 4, wherein when the vertical sync signals are not detected by the detecting device at preset time intervals, the outputting device outputs the self-running sync signals generated by the sync signal generating means, in place of the vertical sync signals.

6. The program embodied in a recording medium according to claim 4, wherein the flat display apparatus driven by the program is a plasma display panel.
